(19) United States
(12) Patent Application Publication
(10) Pub. No.: US 2011/0197162 A1
(43) Pub. Date: Aug. 11, 2011

(54) METHOD AND SYSTEM FOR ORGANIZING INFORMATION WITH SHARABLE USER INTERFACE

(75) Inventors: Xavier Paulik, Saint-Maur-des-Fosses (FR); Dimitri Singer, Paris (FR); Laurent Guyot-Sionnest, Paris (FR)

(73) Assignee: TikiLabs, Paris (FR)

(21) Appl. No.: 13/023,412

(22) Filed: Feb. 8, 2011

Related U.S. Application Data
(60) Provisional application No. 61/303,113, filed on Feb. 10, 2010.

(51) Int. Cl. G06F 3/048

(52) U.S. Cl. 715/810

(57) ABSTRACT

A method including: obtaining a first grid having a first plurality of key zones; obtaining a selection of a second grid corresponding to a first web site and having a second plurality of key zones; assigning a first key zone in the first plurality of key zones to the second grid; and populating the first key zone in the first plurality of key zones with an icon corresponding to the first web site, where the second grid is populated with data associated with the first web site and displayed within a user interface (UI) in response to a selection of the first key zone in the first plurality of key zones.

### CROSS-REFERENCE TO RELATED APPLICATIONS

This patent application claims priority under 35 U.S.C. §119(e) to U.S. Provisional Patent Application Serial No. 61/303,113, entitled: “Method and System for Organizing Information with a Sharable User Interface,” and filed on Feb. 10, 2010, in the names of the same inventors as the present patent application. U.S. Provisional Patent Application Serial No. 61/303,113 is incorporated herein by reference in its entirety.

### BACKGROUND

In the digital convergence and the multi-screen era, users need to browse and access more and more information, using various devices which may have much less resources than a regular desktop with a big screen, a full keyboard, a fast pointer and a strong broadband internet link. Mobile devices are typical of that resources scarcity but also the connected TV and many others. The information browsed and accessed may be of any type and may come from any source, but are very often built and conceived for the desktop. Then, it is often difficult to organize, access and share this vast amount of information with the constraints (e.g. reduced screen size, distant screen, handheld remote) of the growing array of other devices.

### SUMMARY

In general, in one aspect, the invention relates to a method. The method comprises: obtaining a first grid comprising a first plurality of key zones; obtaining a selection of a second grid corresponding to a first web site and comprising a second plurality of key zones; assigning a first key zone in the first plurality of key zones to the second grid; and populating the first key zone in the first plurality of key zones with an icon corresponding to the first web site, wherein the second grid is populated with data associated with the first web site and displayed within a user interface (UI) in response to a selection of the first key zone in the first plurality of key zones.

In general, in one aspect, the invention relates to a non-transitory computer readable storage medium storing instructions. The instructions comprise functionality for: obtaining a selection of a second grid corresponding to a first web site and comprising a second plurality of key zones; assigning a first key zone in the first plurality of key zones to the second grid; and populating the first key zone in the first plurality of key zones with an icon corresponding to the first web site, wherein the second grid is populated with data associated with the first web site and displayed within a user interface (UI) in response to a selection of the first key zone in the first plurality of key zones.

In general, in one aspect, the invention relates to a system. The system comprises: a grid repository storing a first grid comprising a first plurality of key zones and a second grid associated with a web site and comprising a second plurality of key zones; a key zone module (KZM) configured to assign a first key zone in the first plurality of key zones to the second grid and to populate the first key zone in the first plurality of key zones with an icon corresponding to the web site; and an event handler configured to display the second grid in response to a selection of the first key zone in the plurality of key zones.

Other aspects of the invention will be apparent from the following description and the appended claims.

### BRIEF DESCRIPTION OF DRAWINGS

FIG. 1 shows an example grid in accordance with one or more embodiments of the invention.

FIG. 2 shows a block diagram depicting a system in accordance with one or more embodiments of the invention.

FIGS. 3-6 show flowcharts in accordance with one or more embodiments of the invention.

FIGS. 7-10 show grid navigation examples and/or grid functionality examples in accordance with one or more embodiments of the invention.

FIG. 11 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a system and method for organizing information within a sharable user interface. Specifically, there exists a hierarchy (i.e., tree or deck) of grids available for traversal by the user. Each grid has one or more key zones corresponding to one or more objects (e.g., files, user software applications, web pages, web sites, advertisements, child grids in the hierarchy, filter criteria, web page panels, etc.). Following a selection of a key zone, the object corresponding to the key zone is launched and/or a preview of the object corresponding to the key zone is displayed. A user can create custom grids, merge (e.g., concatenate) two or more existing grids, import/export/share grids, etc. Further, a web site may use grids having key zones to control viewing and/or navigation of the content within the web site.

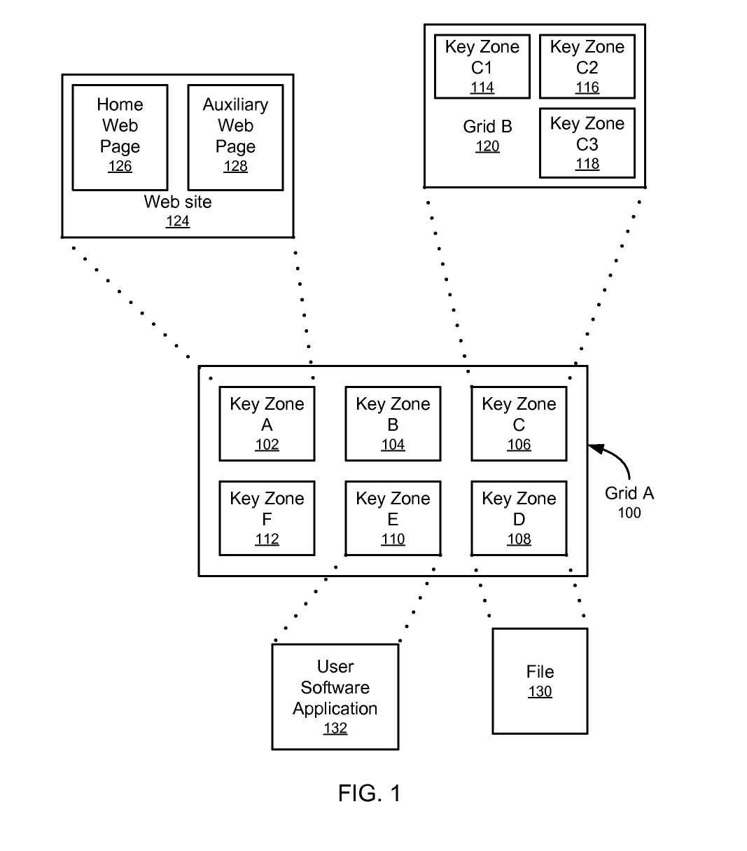

FIG. 1 shows a grid (i.e., Grid A (100)) in accordance with one or more embodiments of the invention. Grid A (100) may be displayed within a user interface (e.g., a touch screen of a mobile device). As shown in FIG. 1, Grid A (100) has multiple key zones (i.e., Key Zone A (102), Key Zone B (104), Key Zone C (106), Key Zone D (108), Key Zone E (110), Key Zone F (112)). The key zones correspond to areas/regions of Grid A (100) that are selectable by the user. Further, each key zone (102, 104, 106, 108, 110, 112) also corresponds to an object (discussed below).

In one or more embodiments of the invention, an object is launched or a preview of the object is displayed depending on how the corresponding key zone is selected. In other words, it is the type of selection or the manner in which the key zone is selected that governs the actions performed on the corresponding object. For example, pressing and holding a key zone (i.e., key zone hold) for a predetermined duration (e.g., 1.5 seconds) is a type of selection. In fact, pressing and holding a key zone for different durations (e.g., 1.5 seconds vs. 5 seconds) may correspond to different types of selections. As yet another example, releasing a key zone (after pressing and holding the key zone) (i.e., key zone release) is a type of selection. Further, selections made by a pointing device (e.g., mouse, track ball, pen, stylus, etc.), by a keyboard/keypad, or by a voice command may all correspond to different types of selections. Further still, a timer may serve as a selection mechanism. Specifically, if a pre-determined amount of time has elapsed and the user has not made a selection, previews for the objects may be generated and displayed in a sequence, with each preview being displayed for a pre-determined amount of time before the next preview in the sequence is generated and/or displayed. Those skilled in the art, having the benefit of this detailed description, will appreciate that many selection types exist in addition to those explicitly mentioned.

As shown in FIG. 1, Key Zone E (110) corresponds to a user software application (132) (e.g., a word processing application, a web browser, an accounting application, a desktop publishing application, a spreadsheet application, a social networking application, etc.). Accordingly, the user software application (132) may be launched (i.e., executed) in response to a selection of Key Zone E (110). Alternatively, a preview of the user software application (132) may be generated and/or displayed in response to a selection of Key Zone E (110). The preview may include a screen shot of the user software application (132) and/or various attributes of the user software application (132) (e.g., size, availability, installation date/time, last executed date/time, last updated date/time, etc.). Whether a preview is displayed or whether the user software application (132) is launched depends on the manner in which Key Zone E (110) is selected (i.e., the type of selection).

As shown in FIG. 1, Key Zone D (108) corresponds to a file (130) (i.e., a document, an image or photograph, a spreadsheet, a slideshow, etc.). Accordingly, the file (130) may be launched (e.g., displayed) (either inside the application that generated the file (130) or an application that can view the file (130)) in response to a selection of Key Zone D (108). Alternatively, a preview of the file (130) may be displayed in response to a selection of Key Zone D (108). The contents of the preview may depend on the type of the file (130). For example, in the case of images or photographs, the preview may include a portion of the file and/or a low-resolution version of the file (130). In the case of word processing documents, the preview may include the headers and/or cover page of the document. The preview may also include attributes of the file (e.g., date/time created, date/time last modified, size, storage location, etc.). Whether a preview of the file (130) is displayed or whether the file (130) itself is launched depends on the manner in which Key Zone D (108) is selected (i.e., the type of selection). In one or more embodiments of the invention, an entire grid corresponds to a file. In such embodiments, each key zone corresponds to a different view or different part of the file (e.g., table of contents, summary, index, list of figures, etc.). Accordingly, the grid is effectively a grid of contents of the file.

Still referring to FIG. 1, Key Zone A (102) corresponds to a web site (124) having a home web page (126) and an auxiliary web page (128). Accordingly, the home web page (126) of the web site (124) may be launched in response to a selection of Key Zone A (102). Alternatively, a preview of the home web page (126) may be displayed in response to a selection of Key Zone A (102). The preview may correspond to a cached version of the home web page (126). Further, the preview may include only a portion of the home web page (126) and/or a low resolution version of the web page. Whether a preview of the home web page (126) is displayed or whether the home web page (126) is launched depends on the manner in which Key Zone A (102) is selected (i.e., the type of selection).

Still referring to FIG. 1, Key Zone C (106) corresponds to Grid B (120) having multiple key zones (i.e., Key Zone C1 (114), Key Zone C2 (116), Key Zone C3 (118)). The multiple key zones (114, 116, 118) of Grid B (120) also correspond to one or more types of objects (i.e., web pages, child grids, user software applications, files, panels, filter criteria, commands, maps, etc.) (not shown). Grid B (120) may be launched (i.e., displayed) in response to a selection of Key Zone C (106). Alternatively, a preview of Grid B (120) may be displayed in response to a selection of Key Zone C (106). The preview may include a scaled (i.e., smaller sized) version of Grid B (120). Whether a preview of Grid B (120) is displayed or whether Grid B (120) is launched depends on the manner in which Key Zone C (106) is selected (i.e., the type of selection).

In one or more embodiments of the invention, Grid A (100) and Grid B (120) correspond to different levels within a hierarchy (i.e., tree or deck) of grids. Specifically, Grid B (120) is a child grid of Grid A (100) within the hierarchy of grids. Similarly, Grid A (100) is a parent grid of Grid B (120) within the hierarchy of grids. Further, Grid A (100) may be a child grid of another grid (not shown) in the hierarchy of grids. The hierarchy or tree of grids may have any number of levels. A user may traverse the hierarchy of grids by selecting key zones that correspond to grids of a different level within the hierarchy. Grids on the bottom of the hierarchy (i.e., grids that have no child grids) may be referred to as “leaf grids”. In contrast, grids that are not “leaf grids” may be referred to as “interior grids.” In one or more embodiments of the invention, all key zones of interior grids correspond to grids (i.e., child grids). Accordingly, in such embodiments of the invention, only leaf grids have key zones corresponding to objects other than grids (e.g., files, web pages, user software applications, etc.).

In one or more embodiments of the invention, the key zones (102, 104, 106, 108, 110, 112) include icons, images, text, video clips, and/or animation associated with their corresponding objects. One or more key zones may be animated in an attempt to attract the user's attention. The animation may occur immediately following display of the grid or following a pre-determined amount of time during which there has been no selection made by the user. Further, the key zones corresponding to grids (e.g., Key Zone C (106)) may display density statistics regarding one or more levels of the hierarchy below the current grid. For example, the density statistics may include the number of levels in the hierarchy below the current grid, the mean or median number of key zones in the child grids below the current grid, etc. Further still, either the key zones themselves or areas in close proximity to the key zones (i.e., above, beside, below the key zones) may display indications relating to the objects of novelties, unread content, paths through the grid hierarchy already explored or not yet explored, etc.

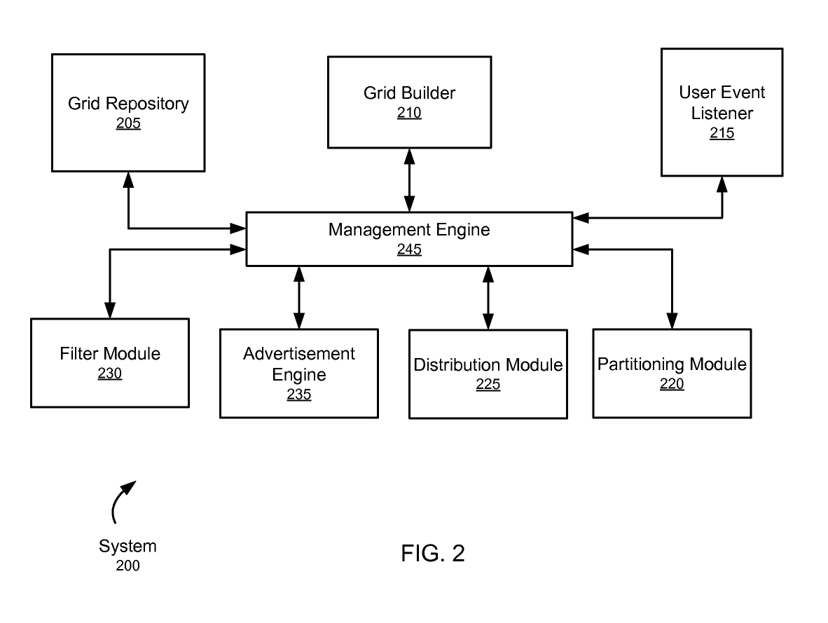

FIG. 2 shows a system (200) in accordance with one or more embodiments of the invention. As shown in FIG. 2, the system (200) has multiple components including a grid repository (205), a grid builder (210), a user event listener (215), a partitioning module (220), a distribution module (225), a filter module (230), an advertisement engine (235), and a management engine (245). Each of these components are described below and may be located on the same hardware device (e.g., a server, mainframe, desktop personal computer (PC), laptop, personal digital assistant (PDA), television, cable box, satellite box, kiosk, smart phone, etc.) or may be located on separate hardware devices connected by a network (e.g., the Internet), with wired and/or wireless segments.

In one or more embodiments of the invention, the grid repository (205) stores grids (e.g., Grid A (100) and Grid B (120), discussed above in reference to FIG. 1). Further, the grid repository (205) may store multiple related grids as a tree or other type of hierarchical structure. The grids stored in the grid repository (205) may be custom grids created by users, grids provided by web sites, and/or grids provided by third-parties. Further, each grid in the grid repository (205) may be referenced (i.e., indexed) by providing a uniform resource locator (URL), a 1-dimensional (1D) and/or 2-dimension (2D) bar code, or another type of key.

In one or more embodiments of the invention, the user event listener (215) identifies selections made by the user while the user is navigating one or more grids. Specifically, the user event listener (215) identifies key zones selected by the user and the manner(s) in which the key zones are selected (i.e., selection types). As yet another example, the event listener (215) includes a timer to identify pre-determined amounts of time during which the user has not made a key zone selection even though a grid is displayed. Accordingly, the user event listener (215) is operatively connected to the user interface (e.g., a touch screen) of the hardware device being operated by the user. Further, the user event listener (215) may track and record user selection patterns within a grid or hierarchy of grids. Further still, the user event listener (215) may match current user behavior, a set of user defined parameters or the current geographic location (i.e., geographic coordinates) of the user, to one or more recorded patterns in order to predict subsequent key zone selections made by the user or propose displays of interest to the user.

In one or more embodiments of the invention, the grid builder (210) is configured to generate grids (e.g., Grid A (100), Grid B (120)) and/or a hierarchy (i.e., tree or deck) of grids. Specifically, the grid builder (210) is configured to generate grids by importing existing grids (e.g., from third-parties) selected by the user and merging (e.g., concatenating) portions of the existing grids and/or by assigning objects (e.g., software applications, files, web pages, web sites, panels (discussed below), commands, maps, filter criteria, other grids, etc.) selected by the user to key zones of one or more grids. Further, the grid builder (210) is also configured to populate the key zones of a grid with icons (i.e., images, clipart, labels, etc.) selected by the user and representing the corresponding objects assigned to the key zones. Accordingly, the grid builder (210) provides an interface through which user selections/input are collected.

In one or more embodiments of the invention, the partitioning module (220) is configured to partition and format a web page into various panels. In one or more embodiments of the invention, each panel is sufficiently small to fit within the user interface (e.g., touch screen) of the user device (e.g., smart phone). In other words, the dimensions of each panel are smaller than the dimensions of the user interface. Further, each panel is assigned (i.e., using the grid builder (210)) to a key zone in a grid associated the web page. A panel may be viewed by selecting its corresponding key zone in the grid.

In one or more embodiments of the invention, the boundary (i.e., perimeter) of each panel is set (i.e., traced) by the user. In such embodiments, the partitioning is performed offline when the user is creating the grid associated with the web page. The grid having key zones corresponding to the panels is retrieved when the web page is next accessed in real-time. Alternatively, the web page may be systematically partitioned into panels of the same size. In such embodiments, both partitioning of the web page into panels and creation of the grid having key zones corresponding to the panels may occur when the web page is encountered for the first time.

In one or more embodiments of the invention, the distribution module (225) is configured to distribute a grid (e.g., Grid A (100), Grid B (120)) and/or a hierarchy (i.e., tree or deck) of grids. Specifically, the distribution module (225) is configured to generate an index (i.e., URL, 1D or 2D barcode, etc.) identifying the grid or hierarchy of grids and distribute the index via social networking sites, email, SMS messages, on-line blogs, etc. to share the grid with other users.

In one or more embodiments of the invention, the filter module (230) is configured to apply one or more filter criteria to the contents of a web page. In other words, the filter module (230) may generate and/or execute algorithms that hide portions of the web page that do not satisfy the selected filter criterion/criteria. Similarly, the filter module (230) may generate and/or execute algorithms that highlight (e.g., change colors, change font sizes, etc.) portions of the web page that satisfy the selected filter criteria/criterion. Each filter criterion may be set (i.e., provided) by a user and assigned (i.e., using the grid builder (210)) to a key zone in a grid associated the web page. In order to apply the desired filter criterion/criteria to the contents of the web page, the corresponding key zone is selected.

In one or more embodiments of the invention, the advertisement engine (235) is configured to select an advertisement for populating a key zone of a grid (e.g., Grid A (100), Grid B (120), etc.). The advertisement may be an image, an animation, a video clip, an audio clip, and/or a link to a web site, etc. Selection of the key zone may launch the advertisement. The advertisement engine (235) may select advertisements based on any criteria, including content previously accessed by the user, search requests issued by the user, etc.

In one or more embodiments of the invention, the management engine (245) provides a link between the grid repository (205), the grid builder (210), the user event listener (215), the partitioning module (220), the distribution module (225), the filter module (230), and the advertisement engine (235). The management engine (245) may be configured to convert data or commands from one format to another format in order to render the components (205, 210, 215, 220, 225, 230, 235) compatible with each other.

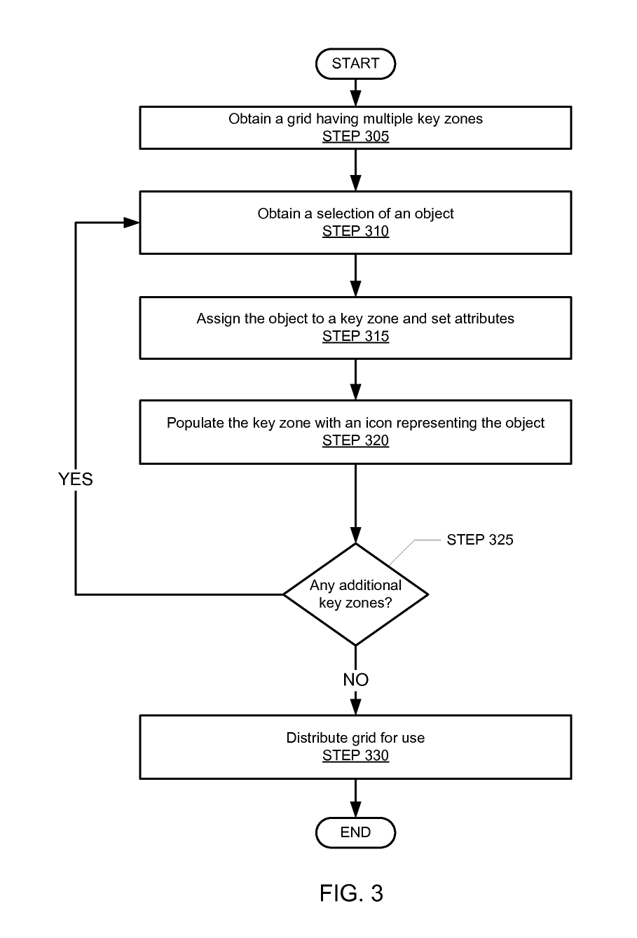

FIG. 3 shows a flowchart in accordance with one or more embodiments of the invention. The process shown in FIG. 3 may be used, for example, with the components of the system (200) (e.g., Grid Builder (210)) to create and distribute a grid (e.g., Grid A (100)) and/or hierarchy of grids. The sequence of steps shown in FIG. 3 may differ among embodiments of the invention, and one or more of the steps may be performed in parallel and/or may be optional.

Initially, a grid having multiple key zones is obtained (STEP 305). The number of key zones in the grid and the arrangement of the key zones (i.e., number of rows and columns) in the grid may be specified by the user. Further, the user may merge (e.g., concatenate) the grid with one or more existing grids (e.g., grids from third-parties) to increase the size of the grid. As discussed above, a grid may be a node within a hierarchy (e.g., tree or deck) of grids having any number of levels. Accordingly, the user may also specify the level/position in the hierarchy to which the grid belongs.

In STEP 310, a selection of an object is obtained. As discussed above, the object may be a web page, a web site, a file, a user software application, panels, filter criteria, another grid corresponding to a web site, a command, etc. Accordingly, the user may select the object by specifying the URL of the web page, the name and path of the file, the name and path of the executable corresponding to the user software application, the index of the other grid, etc. The selection may be made using any combination of GUI widgets including drop- down boxes, lists, file directories, etc.

In STEP 315, the object is assigned to a key zone of the grid. In other words, a link is established between the object and a key zone selected by the user. As discussed above, when the grid is in use, the object is launched or a preview of the object is displayed in response to the key zone being selected. Once the link is established, one or more attributes of the key zone and/or object preview may be set. For example, the user may specify the type of key zone selection (e.g., key zone hold) that triggers the preview of the object. Similarly, the user may specify the type of key zone selection (e.g., key zone release) that triggers the launching of the object. Further, the user may specify the content of the object's preview. For example, in the case of a user software application, the user can select the properties of the user software application (i.e., size, availability, installation date/time, last executed date/time, last updated date/time) to be displayed during a preview. As yet another example, in the case of a web page, the user can specify the portion of the web page to be displayed during a preview of the web page and/or how often (i.e., frequency) the web page should be cached in order to generate an accurate preview of the web page. As yet another example, in the case of another grid, the preview includes a scaled (i.e., smaller) version of the other grid and the user can select the scaling ratio/percentage (e.g., 75%, 60%, etc.).

In STEP 320, the key zone is populated with an icon representing the object. The icon may be selected by the user and may include one or more images, strings, animations, etc. For example, when the object is another grid corresponding to a web site, the icon may be a logo or graphic from the web site. Further, the user may specify the density statistics (discussed above) and/or other indications (i.e., novelties, unread content, paths through the grid hierarchy already explored or not yet explored, etc.) (discussed above) to be displayed within or beside the key zone.

In STEP 325, it is determined whether there exists any addition key zones in the grid that need to be linked to objects. When it is determined that all the key zones are linked to objects, the process proceeds to STEP 330. However, when it is determined that one or more key zones still need to be linked to objects, the process returns to STEP 310.

In STEP 330, the grid is distributed. Specifically, an index (i.e., URL, 1D or 2D barcode, etc.) referencing the grid is created and published/shared on one or more social networking sites, email, SMS messages, on-line blogs, etc.

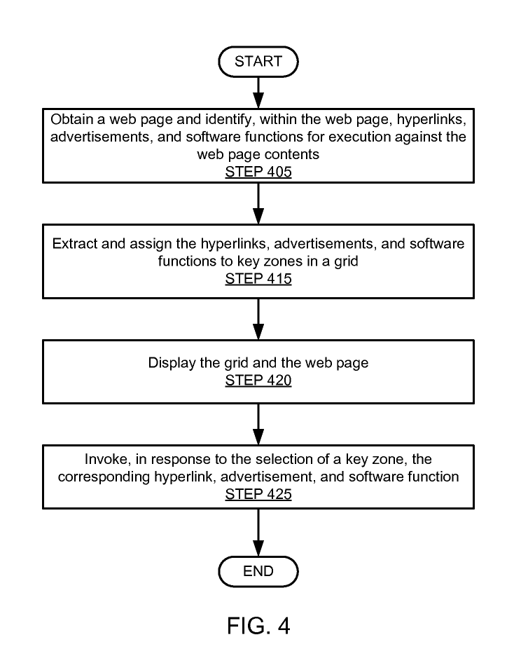

FIG. 4 shows a flowchart in accordance with one or more embodiments of the invention. The process shown in FIG. 4 may be used, for example, with the components of the system (200) to access and/or control the contents of a web site using a grid. The sequence of steps shown in FIG. 4 may differ among embodiments of the invention, and one or more of the steps may be performed in parallel and/or may be optional.

In one or more embodiments of the invention, a web page has one or more hyperlinks. The hyperlinks may reference different web pages from the same site, or web pages from different web sites. User selection of the hyperlinks results in the referenced web pages being launched.

In one or more embodiments of the invention, a web page has one or more software applications. Each software application is a tool that can be executed against the contents of the web page. Further, each software application may rely on parameters provided by the user. Accordingly, the user may control execution of the software application against the content of the web page.

In one or more embodiments of the invention, a web page has one or more advertisements. The advertisements may correspond to images, text, hyperlinks to the advertisers' web sites, video clips, audio clips, animation, etc. presented on the web page.

Initially, a web page is obtained and the objects (i.e., hyperlinks, software applications, and/or advertisements) within the web page are identified (STEP 405). In one or more embodiments of the invention, the hyperlinks, software applications, and/or advertisements may be identified by parsing the markup language (e.g., HTML, XML, etc.) describing/defining the web page.

In STEP 415, the identified hyperlinks, software applications, and/or advertisements are extracted from the web page and assigned to key zones of a grid. The extraction and assignment may be done in a GUI operated by the user. The user may specify which identified hyperlink, software application, and/or advertisement is assigned to which key zone. The user may chose to exclude one or more of the hyperlinks, software applications, and/or advertisements from being assigned to a key zone of the grid. Further, the user may set the type of key zone selections (i.e., key zone hold, key zone release, etc.) that will launch the objects within the web page and/or the type of key zone selections that will trigger previews of the objects assigned to the key zones. Further still, the user may select icons representing the corresponding hyperlinks, software applications, and/or advertisements in the web page to populate the key zones of the grid.

Although the STEPS of the process in FIG. 4 focus heavily on hyperlinks, software applications, and/or advertisements within the web page, the grid may be loaded with any object selected by the user from any source. For example, the grid may be loaded with custom software applications that are not found within the web page but rather are developed by the user or another third-party for execution against the contents of the web page. Similarly, the user may load the grid with hyperlinks not found within the web page. For example, if the web page corresponds to a retailer, the user may load the grid with one or more hyperlinks to a competitor of the retailer.

In STEP 420, the grid and the web page are displayed. In one or more embodiments of the invention, the grid is retrieved and displayed in response to displaying the web page. In one or more embodiments of the invention, the web page is displayed in response to the user accessing the grid. In one or more embodiments of the invention, the grid is the object being assigned to the key zone in STEP 315 (discussed above in reference to FIG. 3) and thus may be accessed by selecting the key zone in STEP 315.

In STEP 425, a selection of a key zone in the grid is identified and the object corresponding to the selected key zone is invoked (i.e., launched or previewed) according to the selection type. The selection may correspond to a user pressing and holding the key zone (i.e., key zone hold), the user releasing the key zone (after pressing the key zone) (i.e., key zone release), a click from a pointing device (i.e., trackball, mouse, stylus, pen, etc.), a voice command, etc. In the case of a hyperlink, the referenced web page is launched (or even previewed depending on the selection type) in response to the selection of the key zone. In the case of an advertisement, the image, video clip, audio clip, etc. is displayed/played in response to the selection of the key zone. Further, the web page of the advertiser may be launched in response to the selection of the key zone. Further still, in the case of a software application, the software application is executed against the content of the web site using the parameters (if any) provided by the user in response to the selection of the key zone. Moreover, the content and the appearance of the web page may change as a result of executing the software application.

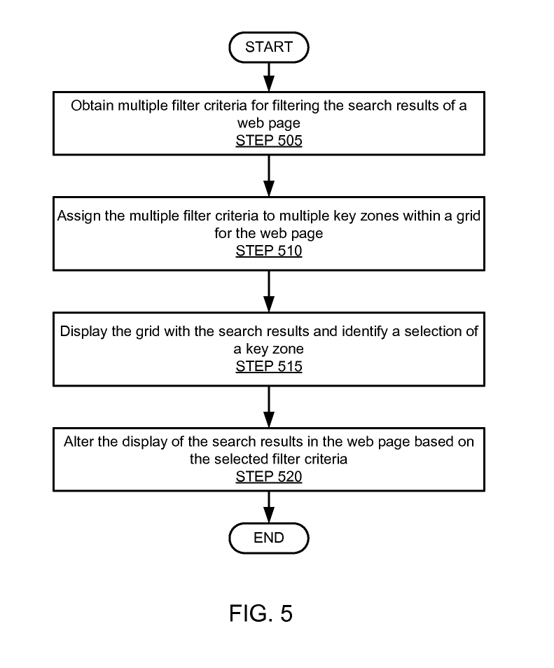

FIG. 5 shows a flowchart in accordance with one or more embodiments of the invention. The process shown in FIG. 5 may be used, for example, with the components of the system (200) (e.g., the filter module (220)) to filter the search results displayed within a web page using a grid. The sequence of steps shown in FIG. 5 may differ among embodiments of the invention, and one or more of the steps may be performed in parallel and/or may be optional.

Initially, one or more filter criteria for filtering the search results of a web page are obtained (STEP 505). The filter criteria may be identified from the web page by, for example, parsing the markup language (i.e., HTML, XML) describing/defining the web page. Alternatively, the filter criteria may be explicitly specified by the user using one or more GUI widgets (i.e., drop-down lists, radio buttons, text boxes, etc.). In one or more embodiments of the invention, each filter criterion corresponds to a source (e.g., search engine) of one or more of the search results.

In STEP 510, the multiple filter criteria are assigned to key zones of a grid.

The assignment may be done in a GUI operated by the user. The user may specify which filter criterion is assigned to which key zone. The user may chose to exclude one or more of the filter criteria from assignment to a key zone. Further, the user may set the type of key zone selections (i.e., key zone hold, key zone release, etc.) that will apply the assigned search criterion or criteria to the search results. Further still, the user may select icons representing the corresponding search criteria to populate the key zones of the grid.

In STEP 515, the grid and the web page with the search results are displayed. In one or more embodiments of the invention, the grid is retrieved and displayed in response to the search results becoming available. In one or more embodiments of the invention, the web page is displayed in response to the user accessing the grid. In one or more embodiments of the invention, the grid is the object being assigned to the key zone in STEP 315 (discussed above in reference to FIG. 3) and thus may be accessed by selecting the key zone in STEP 315.

In STEP 520, a selection of a key zone is identified and the corresponding filter criteria is applied to the search results. In response to applying the filter criteria, the display of the search results is altered. For example, all search results that do not satisfy the selected filter criteria may be hidden. As yet another example, all search results that do satisfy the selected filter criteria may be emphasized using an increased font size, a different font style, highlighting, background shading, etc.

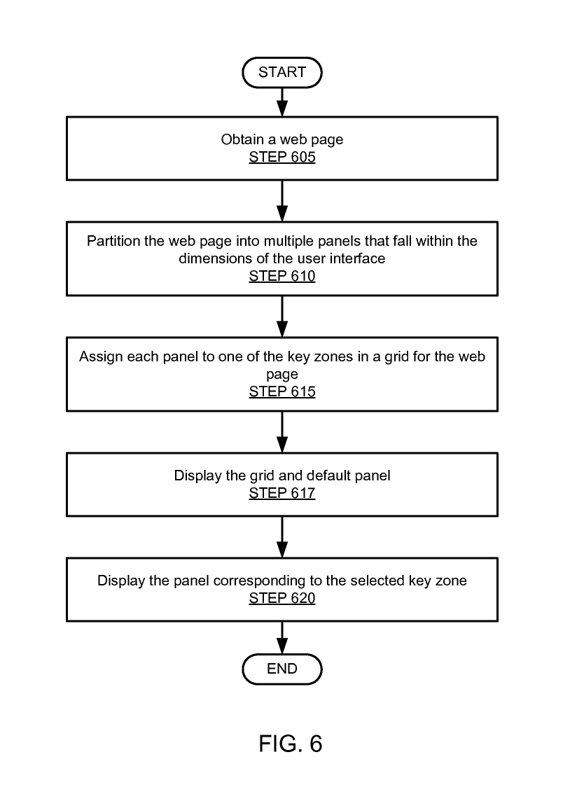

FIG. 6 shows a flowchart in accordance with one or more embodiments of the invention. The process shown in FIG. 6 may be used, for example, with the components of the system (200) (e.g., the partitioning module (220)) to partition a web page into panels and display one or more of the panels using a grid. The sequence of steps shown in FIG. 6 may differ among embodiments of the invention, and one or more of the steps may be performed in parallel and/or may be optional.

Initially, a web page is obtained (STEP 605). In one or more embodiments of the invention, one or more dimensions of the web page exceed the size of the user interface (e.g., touch screen) of the user device (e.g., smart phone). The web page may have any type of content and may originate from any source.

In STEP 610, the web page is partitioned into multiple panels. Each panel has one or more dimensions that are smaller than the dimensions of the user interface. In one or more embodiments of the invention, the user specifies (i.e., traces) the boundary (i.e., perimeter) of each panel. In such embodiments, the panels may have different sizes and shapes. Alternatively, the user may request that the web page be partitioned into multiple panels have identical sizes and shapes.

In STEP 615, a grid having multiple key zones is obtained and each panel is assigned to one of the multiple key zones. The user may specify which panel is assigned to which key zone. The user may chose to exclude one or more of the panels from being assigned to a key zone of the grid. Further, the user may set the type of key zone selections (i.e., key zone hold, key zone release, etc.) that will launch and/or preview the panels assigned to the key zones. Further still, the user may select icons representing the assigned panels to populate the key zones of the grid. Accordingly, a key zone may have an image or an icon depicting the portion of the web page (i.e., panel) associated with the key zone. In one or more embodiments of the invention, the user sets one of the panels as the default panel.

In STEP 617, the grid and a default panel are displayed. In one or more embodiments of the invention, the grid is retrieved and displayed in response to the user accessing the web page. In one or more embodiments of the invention, the default panel is displayed in response to the user accessing the grid. In one or more embodiments of the invention, the grid is the object being assigned to the key zone in STEP 315 (discussed above in reference to FIG. 3) and thus may be accessed by selecting the key zone in STEP 315.

In STEP 620, a selection of a key zone is identified and the corresponding panel is displayed. The selection may correspond to a user pressing and holding the key zone (i.e., key zone hold), the user releasing the key zone (after pressing the key zone) (i.e., key zone release), a click from a pointing device (i.e., trackball, mouse, stylus, pen, etc.), a voice command, etc.

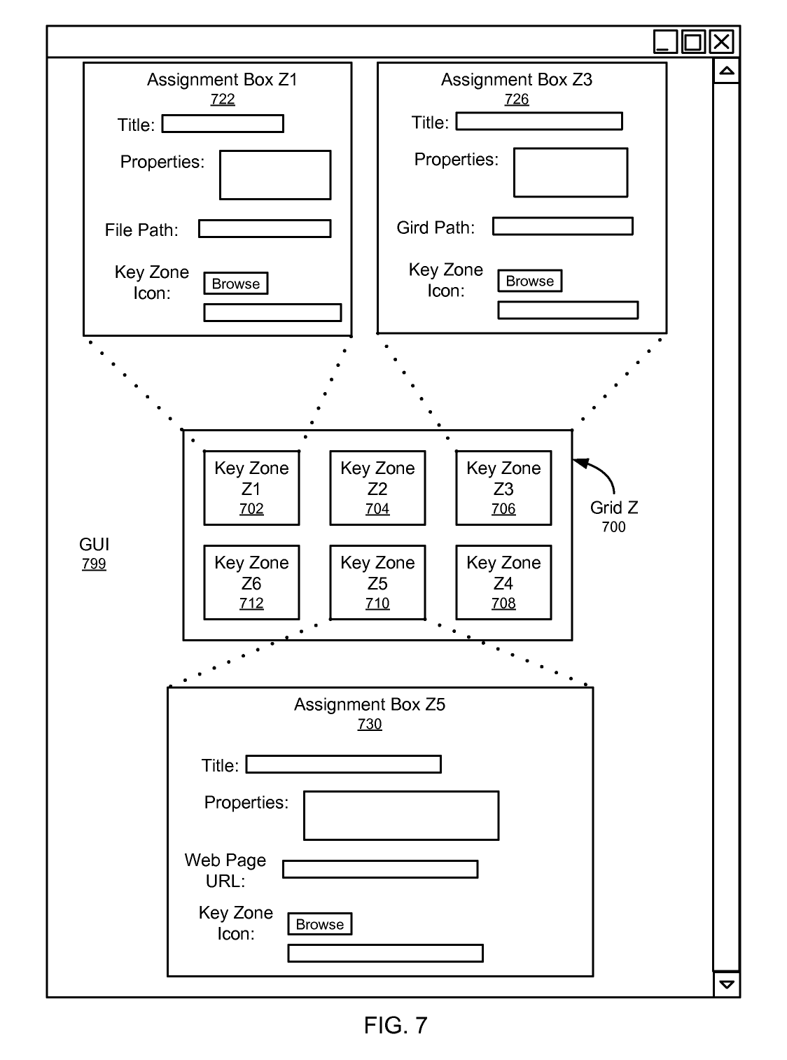

FIG. 7 shows an example in accordance with one or more embodiments of the invention. As shown in FIG. 7, there exists a GUI (799) having a grid (i.e., Grid Z (700)). As also shown in FIG. 7, Grid Z (700) includes multiple key zones (i.e., Key Zone Z1 (702), Key Zone Z2 (704), Key Zone Z3 (706), Key Zone Z4 (708), Key Zone Z5 (710), Key Zone Z6 (712)). The GUI (799) may used by a user to customize Grid Z (700). Specifically, the GUI (799) may be used to assign objects (i.e., web pages, web sites, files, commands, maps, user software applications, other grids, panels, filter criteria, etc.) to one or more of the key zones (702, 704, 706, 708, 710, 712).

Still referring to FIG. 7, there exists multiple assignment boxes (i.e.,

Assignment Box Z1 (722), Assignment Box Z3 (726), and Assignment (Z5 (730)). The assignment boxes (722, 726, 730) are features of the GUI (799) used to assign objects to the key zones. Specifically, Assignment Box Z1 (722) is used to assign an object to Key Zone Z1 (702). Similarly, Assignment Box Z3 (726) is used to assign an object to Key Zone Z3 (706). Further, Assignment Box Z5 (730) is used to assign an object to Key Zone Z5 (710).

As shown in FIG. 7, one or more of the assignment boxes (722, 726, 730) include GUI widgets for identifying/specifying/selecting/setting the title of the object for assignment, the type of key zone selections (i.e., key zone hold, key zone release, etc.) that will launch and/or preview the object (i.e., properties), attributes of the object's preview (i.e., properties), the location of the object (i.e., file path, gird path, web page URL), and the location of the icon representing the object for populating the key zone. The scenario(s) depicted by FIG. 7 may be tied to the process described in FIG. 3.

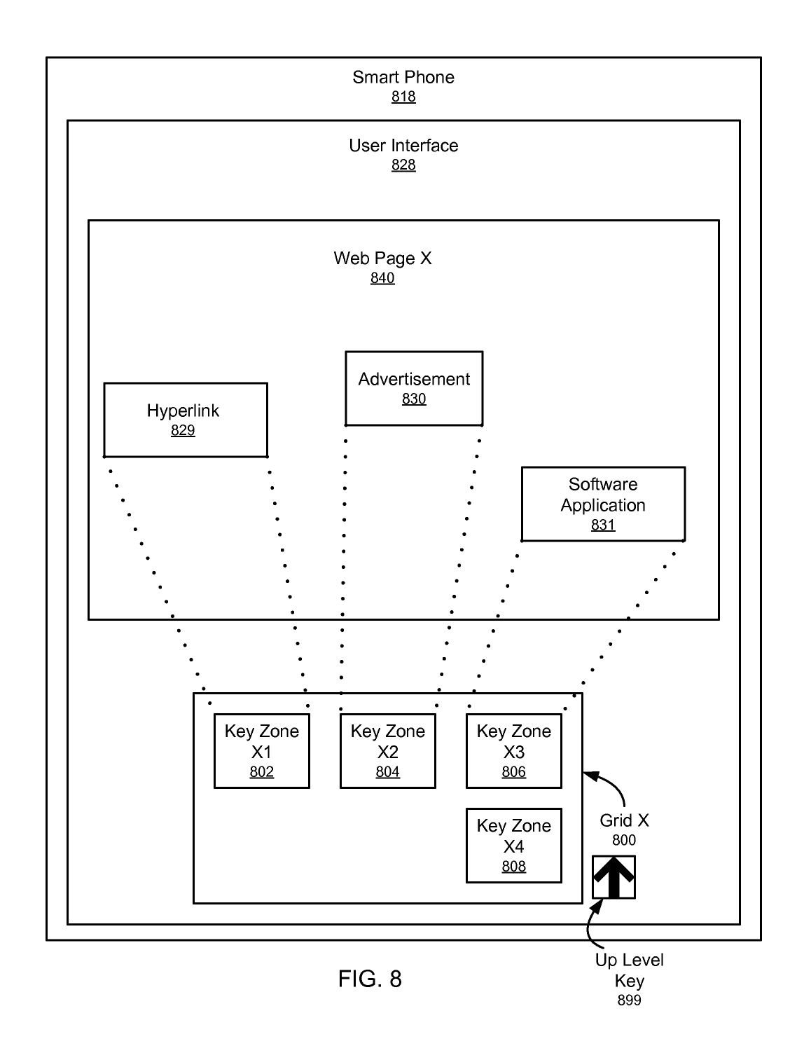

FIG. 8 shows an example in accordance with one or more embodiments of the invention. As shown in FIG. 8, there exists a smart phone (818) having a user interface (828). The user interface (828) may correspond to any portion of the smart phone's touch screen.

As also shown in FIG. 8, Grid X (800) is displayed with Web Page X (840) in the user interface (828). The Web Page X (840) includes a hyperlink (829), an advertisement (830), and a software function (831). The hyperlink (829) may reference a web page from the same site as Web Page X (840), or a web page from a different web site. The software application (831) may be a tool for execution by the user against the content of Web Page X (840). Further, the software application (831) may execute based on parameters provided by the user. The advertisement (830) may correspond to an image, a hyperlink, a video clip, an audio clip, an animation, etc.

Grid X (800) may be created by a user in order to customize the viewing of Web Page X (840). As shown in FIG. 8, Grid X (800) includes multiple key zones (i.e., Key Zone X1 (802), Key Zone X2 (804), Key Zone X3 (806), Key Zone X4 (808)). The user has requested the hyperlink (829), the advertisement (830), and the software application (831) be extracted from Web Page X (840) and assigned to key zones (802, 804, 806), respectively. The user may also assign a custom software application (i.e., a software application that was not included with Web Page X (840)) to Key Zone X4 (808). Further, one or more advertisements that are not part of Web Page X (840) (e.g., advertisements selected by the advertisement engine (235), discussed above in reference to FIG. 2), may populate one or more key zones (802, 804, 806, 808) of Grid X (800).

Following a selection of a key zone in Grid X (800), the corresponding object is launched. For example, in the case of the hyperlink (829), the referenced web page is launched (or even previewed depending on the selection type). In the case of the advertisement (830), the image, video clip, audio clip, etc. is displayed/played. Further, the web page of the advertiser may be launched. In the case of the software application (831), the software application is executed against the content of Web Page X (840) based on the parameters (if any) provided by the user. Moreover, the content and the appearance of Web Page X (840) may change as a result of executing the software application. The scenario(s) depicted by FIG. 8 may be tied to the process described in FIG. 4. Further, Grid X (800) may be assigned by the user to one of the key zones of Grid Z (700), discussed above in reference to FIG. 7. The Up Level Key (899) may be used to return to Grid Z (700).

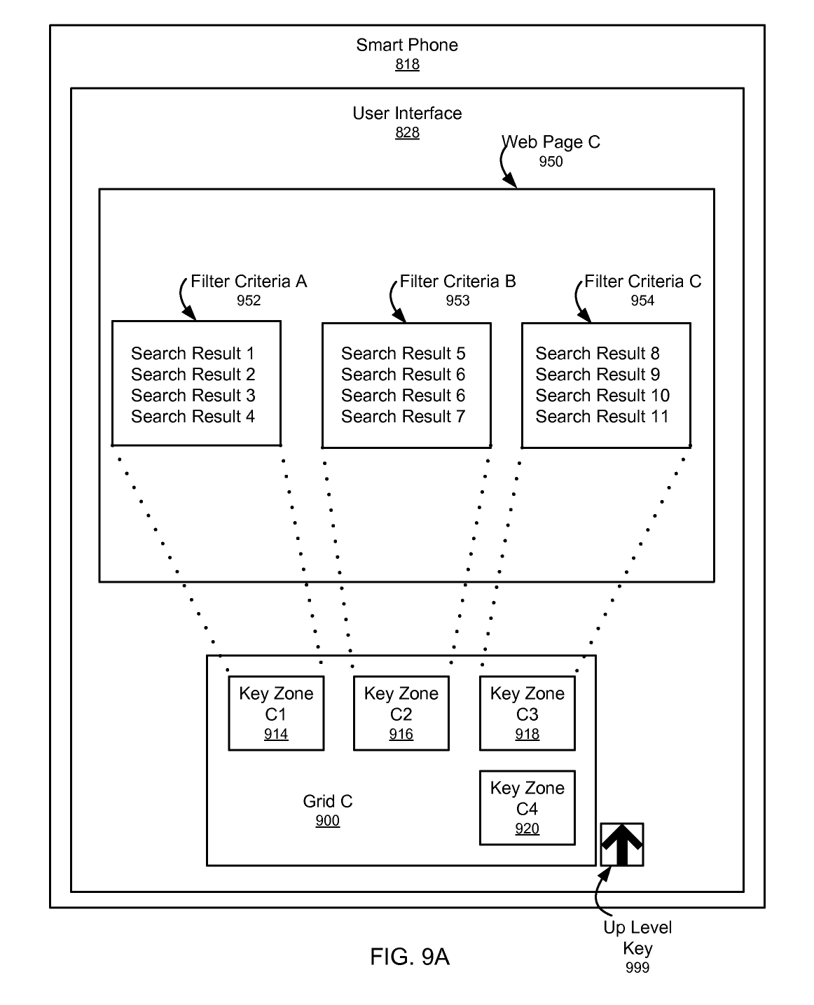

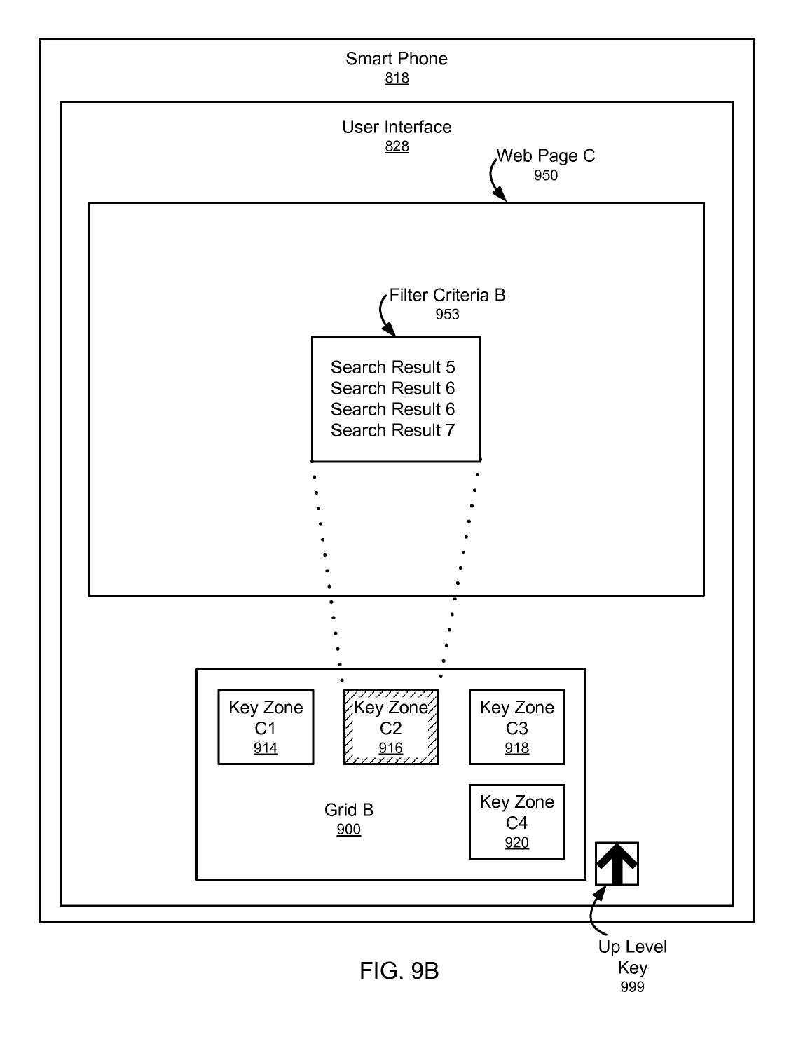

FIG. 9A shows an example in accordance with one or more embodiments of the invention. As shown in FIG. 9A, there exists a web page (i.e., Web Page C (950)) having multiple search results. As also shown in FIG. 9A, there exists a grid (i.e., Grid C (900)) having multiple key zones (i.e., Key Zone C1 (914), Key Zone C2 (916), Key Zone C3 (918), and Key Zone C4 (920)). Both Web Page C (950) and Grid C (900) are displayed within the user interface (828) of the smart phone (818). Grid C (900) may be assigned to a key zone of Grid Z (700), discussed above in reference to FIG. 7. The Up Level Key (999) may be used to return to Grid Z (700).

Still referring to FIG. 9A, the user has assigned different filter criteria to different key zones. Specifically, Filter Criteria A (952) is assigned to Key Zone C1 (914). Similarly, Filter Criteria B (953) is assigned to Key Zone C2 (916). Further, Filter Criteria C (954) is assigned to Key Zone C3 (918). The filter criteria may be identified from Web Page C (950) by, for example, parsing the markup language (i.e., HTML, XML) describing/defining Web Page C (950). Alternatively, the filter criteria may be explicitly specified by the user using one or more GUI widgets (i.e., drop-down lists, radio buttons, text boxes, etc.). In one or more embodiments of the invention, each filter criterion corresponds to a source of one or more of the search results. Specifically, Filter Criteria A (952) corresponds to search results retrieved by a first search engine, Filter Criteria B (953) corresponds to search results retrieved by a second search engine, and Filter Criteria C (954) corresponds to search results retrieved by a third search engine.

Following a selection of a key zone in Grid C (900), the corresponding filter criteria (952, 953, 954) is applied to the search results of Web page C (950).

In FIG. 9B, the user has selected Key Zone C2 (916) in Grid B (900). As discussed above, the user has assigned Filter Criteria B (953) to Key Zone C2 (916). As also discussed above, Filter Criteria B (953) corresponds to search results retrieved by a specific search engine. As shown in FIG. 9B, Filter Criteria B (953) has been applied to the contents of Web Page C (950), and all search results not satisfying Filter Criteria B (953) (i.e., search results not retrieved from the specific search engine) are hidden. The scenario(s) described in FIGS. 9A and 9B are tied to the process in FIG. 5.

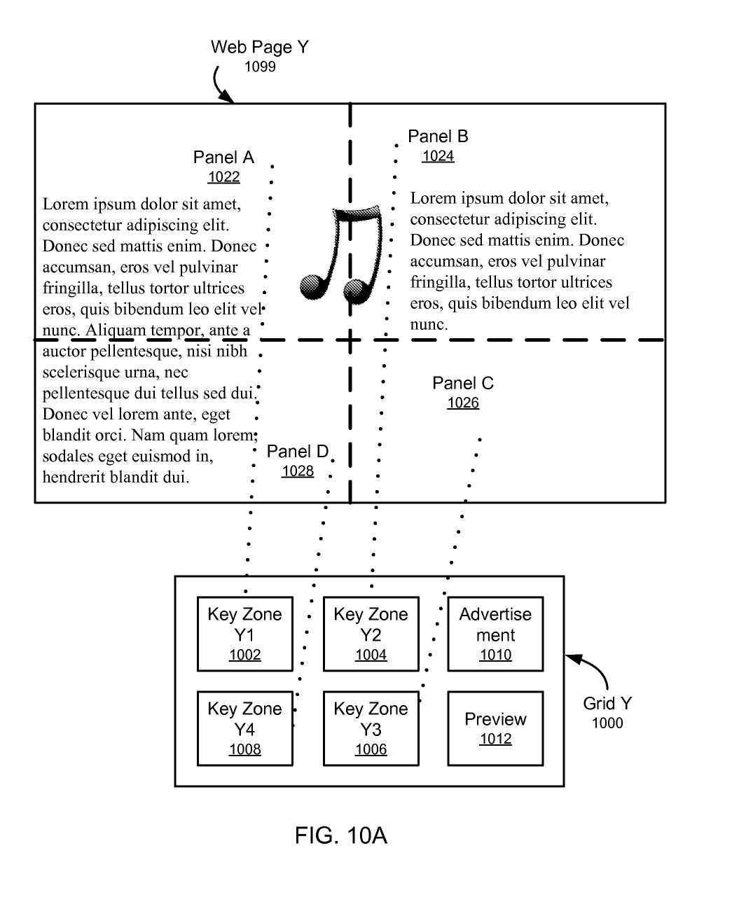

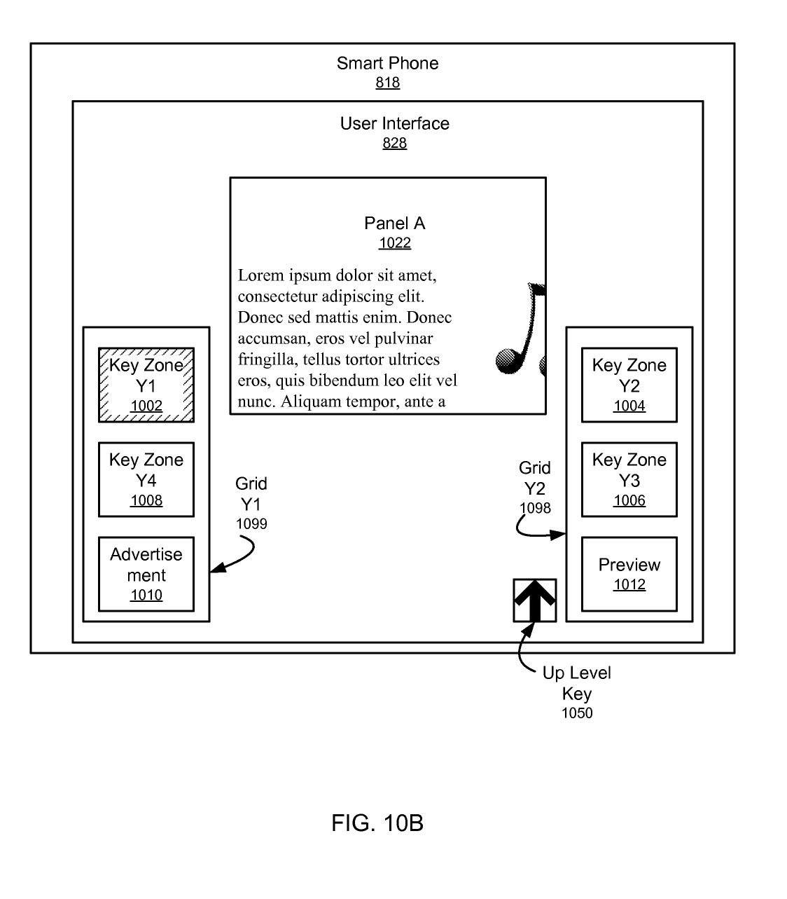

FIG. 10A shows an example in accordance with one or more embodiments of the invention. As shown in FIG. 10A, there exists a large web page (i.e., Web Page Y (1099)) and a grid (i.e., Grid Y (1000)). The user has partitioned Web Page Y (1099) into multiple panels (1022, 1024, 1026, 1028). In other words, the user has specified the shape, size, and location of the panels (1022, 1024, 1026, 1028).

As also shown in FIG. 10A, Grid Y (1000) has multiple key zones (i.e., Key Zone Y1 (1002), Key Zone Y2 (1004), Key Zone Y3 (1006), Key Zone Y4 (1008), Advertisement (1010), Preview (1012)). Each panel (1022, 1024, 1026, 1028) is assigned by the user to one of the key zones (1002, 1004, 1006, 1008). Specifically, Panel A (1022) is assigned to Key Zone Y1 (1002); Panel B (1024) is assigned to Key Zone Y2 (1004), Panel C (1026) is assigned to Key Zone Y3 (1006); and Key Zone Y4 (1008) is assigned to Panel D (1028). Those skilled in the art, having the benefit of this detailed description, will appreciate that the key zones corresponding to panels (i.e., Key Zone Y1 (1002), Key Zone Y2 (1004), Key Zone Y3 (1006), Key Zone Y4 (1008)) are arranged to patch the layout of the panels (1022, 1024, 1026, 1028). For example, Key Zone Y4 (1008) is below Key Zone Y1 (1002), just like Panel D (1028) is below Panel A (1022).

As also shown in FIG. 10A, the right-hand side of Grid Y (1000) includes two reserved key zones: the advertisement key zone (1010) and the preview key zone (1012). The advertisement key zone (1010) is populated with an advertisement (e.g., an advertisement selected by the Advertisement Engine (235), discussed above in reference to FIG. 2). Upon selection of the advertisement key zone (1010), the advertisement is launched. In contrast, upon selection of the preview key zone (1012), a scaled (i.e., reduced) version of the full web page Y (1099) is displayed. Those skilled in the art, having the benefit of this detailed description, will appreciate that other special/reserved key zones may take the place of the advertisement key zone (1010) and/or the preview key zone (1012).

FIG. 10B shows an example in accordance with one or more embodiments of the invention. As shown in FIG. 10B, Grid Y (1000) is split into two grids: Grid Y1 (1099) and Grid Y2 (1098), each having a single column. Any grid may be split as shown in FIG. 10B. Grid Y1 (1099) and Grid Y2 (1098) are displayed on opposite sides of the user interface (828) (e.g., below each of the user's hands). Further, Key Zone Y1 (1002) is selected by the user (i.e., denoted using diagonal lines across Key Zone Y1 (1002)). In response to the selection of Key Zone Y1 (1002), Panel A (1022) is displayed. As also shown in FIG. 10B, the dimensions of Panel A (1022) are less than the dimensions of the user interface (828). Accordingly, large Web Site Y (1099), of FIG. 10A, may successfully be displayed within the constraints of the smart phone (818) by partitioning the Web Site Y (1099) into panels and assigning the panels to the key zones (1002, 1004, 1006, 1008) of Grid Y (1000). The scenario(s) depicted by FIG. 10A and 10B may be tied to the process described in FIG. 6. Further, Grid Y (1000) may be assigned by the user to one of the key zones (702, 704, 706, 708, 710, 712) of Grid Z (700), discussed above in reference to FIG. 7.

Embodiments of the invention have one or more of the following advantages: the ability to provide a user interface suitable for the constraints of a mobile device (e.g., smaller screen size, fewer commands, slower connection to the Internet, etc.); the ability to organize and quickly access views of the web; the ability to store, share, manage, and quickly access (i.e., surf) links to web pages; the ability to organize icons and/or menu features that are frequently accessed; the ability to reduce the time spent searching, navigating, exploring, going back, trying again, and finally acquiring desired content from the web; the ability to share content (e.g., web pages, grids) with other users; the ability to reduce time spent jumping between frequently accessed web pages; etc.

Although FIGS. 8-10 are heavy focused on the smart phone (818) having the touch screen user interface (828), those skilled in the art, having the benefits of this detailed description, will appreciate the examples are equally valid using other types of user hardware devices (e.g., kiosks, cable boxes, televisions, desktop computers, etc.). Key zones selections may be accomplished using a touch screen, a keyboard/keypad, a pointing device (i.e., mouse, trackball), voice commands, etc.

Although FIGS. 8-10 are heavily focused on the existence of the Up Level Keys (899, 999, 1050), those skilled in the art, having the benefit of this detailed description, will appreciate that there exists other methods for navigation to a parent grid. For example, a user may slide a finger or stylus outside the current grid and then release the finger or stylus to navigate to the parent grid.

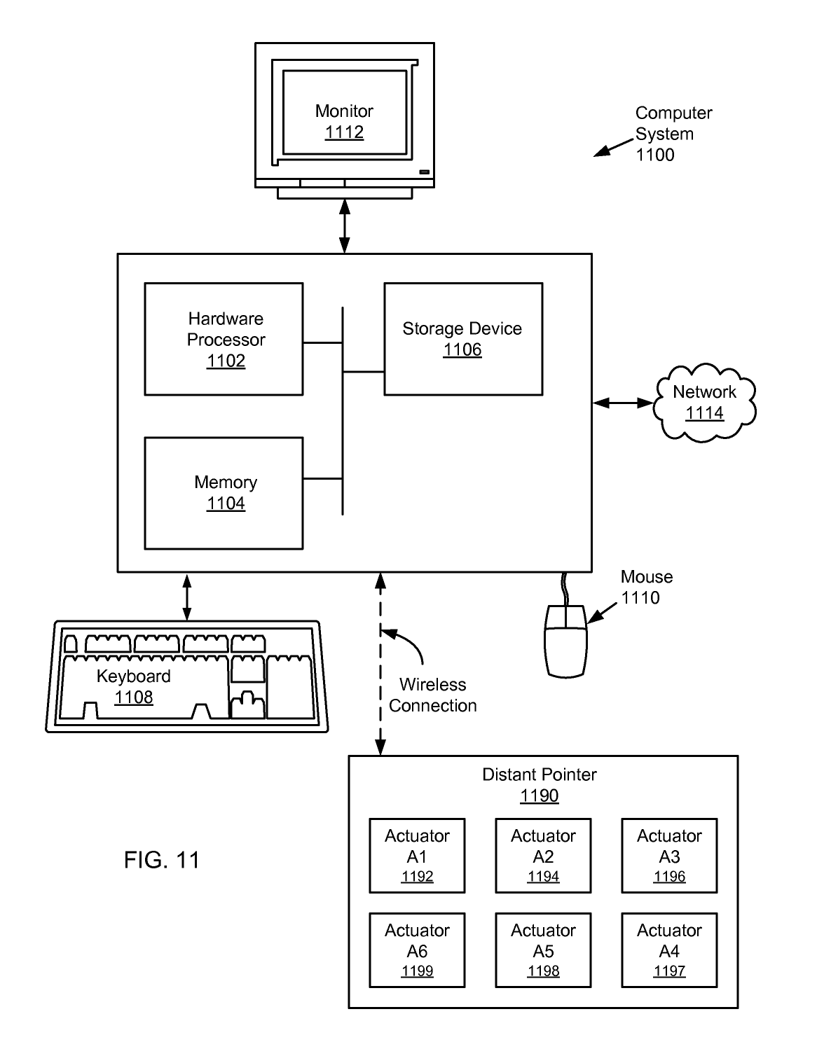

Embodiments of the invention may be implemented on virtually any type of computer (including mobile computers) regardless of the platform being used. For example, as shown in FIG. 11, computer system (1100) includes one or more processor(s) (1102), associated memory (1104) (e.g. random access memory (RAM), cache memory, flash memory, etc.), storage device (1106) (e.g. a hard disk, an optical drive such as a compact disk drive or digital video disk (DVD) drive, a flash memory stick, etc.), and numerous other elements and functionalities typical of today's computers (not shown). In one or more embodiments of the invention, processor (1102) is hardware. For example, the processor may be an integrated circuit. Computer system (1100) may also include input means, such as keyboard (1108), mouse (1110), or a microphone (not shown). Further, computer system (1100) may include output means, such as monitor (1112) (e.g. a liquid crystal display (LCD), a plasma display, or cathode ray tube (CRT) monitor). Computer system (1100) may be connected to network (1114) (e.g. a local area network (LAN), a wide area network (WAN) such as the Internet, or any other type of network) via a network interface connection (not shown). In one or more embodiments of the invention, many different types of computer systems exist, and the aforementioned input and output means may take other forms. Generally speaking, computer system (1100) includes at least the minimal processing, input, and/or output means necessary to practice embodiments of the invention.

In one or more embodiments of the invention, the computer system (1100) includes a distant pointer (1190) which is wirelessly connected to the rest of the computer system (1100). As shown in FIG. 11, the distance pointer (1190) includes multiple actuators (i.e., Actuator Al (1192), Actuator A2 (1194), Actuator A3 (1196), Actuator A4 (1197), Actuator A5 (1198), Actuator A6 (1199)). The distant pointer (1190) is a hardware device that acts as a remote control. The actuators (1192, 1194, 1196, 1197, 1198, 1199) correspond to the key zones displayed on the monitor (1112). Accordingly, the user may remotely select the key zones displayed on the monitor (1112) using the actuators (1192, 1194, 1196, 1197, 1198, 1199) of the distant pointer (1190).

Further, in one or more embodiments of the invention, one or more elements of the aforementioned computer system (1100) may be located at a remote location and connected to the other elements over a network. Further, embodiments of the invention may be implemented on a distributed system having a plurality of nodes, where each portion of the invention (e.g. data structure, converter module, layout engine) may be located on a different node within the distributed system. In one embodiment of the invention, the node corresponds to a computer system. Alternatively, the node may correspond to a processor with associated physical memory. The node may alternatively correspond to a processor or micro-core of a processor with shared memory and/or resources. Further, software instructions in the form of computer readable program code to perform embodiments of the invention may be stored, temporarily or permanently, on a non-transitory computer readable storage medium, such as a compact disc (CD), a diskette, punch cards, a tape, a memory stick, a flash drive, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method, comprising:
obtaining a first grid comprising a first plurality of key zones;
obtaining a selection of a second grid corresponding to a first web site and comprising a second plurality of key zones;
assigning a first key zone in the first plurality of key zones to the second grid; and
populating the first key zone in the first plurality of key zones with an icon corresponding to the first web site,
wherein the second grid is populated with data associated with the first web site and displayed within a user interface (UI) in response to a selection of the first key zone in the first plurality of key zones.

2. The method of claim 1, further comprising:
obtaining a selection of a third grid corresponding to a second web site; and
assigning a second key zone in the first plurality of key zones to the third grid, obtaining a selection of a software application; and
assigning a third key zone in the first plurality of key zones to the software application,
wherein the third grid is displayed after a selection of the second key zone in the first plurality of key zones, and
wherein the software application is executed after a selection of the third key zone is the first plurality of key zones.

3. The method of claim 1, further comprising:
partitioning a web page of the first web site into a plurality of panels, wherein the web page comprises a dimension exceeding a dimension of the UI; and
assigning a first key zone in the second plurality of key zones to a panel of the plurality of panels,
wherein the panel is displayed within the UI in response to a selection of the first key zone in the second plurality of key zones.

4. The method of claim 1, further comprising:
extracting a plurality of web links from a web page of the first web site; and
assigning a first key zone in the second plurality of key zones to a web link of the plurality of web links,
wherein the web link is accessed in response to a selection of the first key zone in the second plurality of second zones.

5. The method of claim 1, further comprising:
receiving a selection of a first web page of the first web site;
assigning a first key zone in the second plurality of key zones to the first web page;
receiving a selection of a second web page of the first web site; and
assigning a second key zone in the second plurality of key zones to the second web page,
wherein the first web page is previewed within the UI in response to a selection of the first key zone in the second plurality of key zones,
wherein the selection of the first key zone is a key zone hold,
wherein the second web page is displayed within the UI in response to a selection of the second key zone in the second plurality of key zones, and
wherein the selection of the second key zone is a key zone release.

6. The method of claim 1, further comprising:
obtaining a plurality of filter criteria for filtering a plurality of search results from a web page of the first web site; and
assigning a first key zone in the second plurality of key zones to a filter criterion of the plurality of filter criteria,
wherein the filter criteria is applied to the plurality of search results in response to a selection of the first key zone in the second plurality of key zones.

7. The method of claim 6, wherein the plurality of filter criteria corresponds to a plurality of search engines.

8. The method of claim 1, further comprising:
obtaining a third grid by accessing a uniform resource link (URL) referencing the third grid; and
generating a home grid for a first user by concatenating the first grid and the third grid.

9. The method of claim 8, further comprising:
sharing the home grid with a second user using at least one selected from a group consisting of a social networking site, a 2D code, and a short message service (SMS).

10. A computer readable medium storing instructions comprising functionality to:
obtain a first grid comprising a first plurality of key zones;
obtain a selection of a second grid corresponding to a first web site and comprising a second plurality of key zones;
assign a first key zone in the first plurality of key zones to the second grid; and
populate the first key zone in the first plurality of key zones with an icon corresponding to the first web site,
wherein the second grid is populated with data associated with the first web site and displayed within a user interface (UI) in response to a selection of the first key zone in the first plurality of key zones.

11. The computer readable medium of claim 10, the instructions further comprising functionality to:
obtain a selection of a third grid corresponding to a second web site; and
assign a second key zone in the first plurality of key zones to the third grid, obtain a selection of a software application; and
assign a third key zone in the first plurality of key zones to the software application,
wherein the third grid is displayed after a selection of the second key zone in the first plurality of key zones, and
wherein the software application is executed after a selection of the third key zone is the first plurality of key zones.

12. The computer readable medium of claim 10, the instructions further comprising functionality to:
partition a web page of the first web site into a plurality of panels, wherein the web page comprises a dimension exceeding a dimension of the UI; and
assign a first key zone in the second plurality of key zones to a panel of the plurality of panels,
wherein the panel is displayed within the UI in response to a selection of the first key zone in the second plurality of key zones.

13. The computer readable medium of claim 10, the instructions further comprising functionality to:
extract a plurality of web links from a web page of the first web site; and
assign a first key zone in the second plurality of key zones to a web link of the plurality of web links,
wherein the web link is accessed in response to a selection of the first key zone in the second plurality of second zones.

14. The computer readable medium of claim 10, the instructions further comprising functionality to:
receive a selection of a first web page of the first web site;
assign a first key zone in the second plurality of key zones to the first web page;
receive a selection of a second web page of the first web site; and
assign a second key zone in the second plurality of key zones to the second web page,
wherein the first web page is previewed within the UI in response to a selection of the first key zone in the second plurality of key zones,
wherein the selection of the first key zone is a key zone hold,
wherein the second web page is displayed within the UI in response to a selection of the second key zone in the second plurality of key zones, and
wherein the selection of the second key zone is a key zone release.

15. The computer readable medium of claim 10, the instructions further comprising functionality to:
obtain a plurality of filter criteria for filtering a plurality of search results from a web page of the first web site; and
assign a first key zone in the second plurality of key zones to a filter criterion of the plurality of filter criteria,
wherein the filter criteria is applied to the plurality of search results in response to a selection of the first key zone in the second plurality of key zones.

16. A system comprising:
a grid repository storing a first grid comprising a first plurality of key zones and a second grid associated with a web site and comprising a second plurality of key zones;
a key zone module (KZM) configured to assign a first key zone in the first plurality of key zones to the second grid and to populate the first key zone in the first plurality of key zones with an icon corresponding to the web site; and
an event handler configured to display the second grid in response to a selection of the first key zone in the plurality of key zones.

17. The system of claim 16, further comprising:
a partitioning module configured to partition a web page of the web site into a plurality of panels,
wherein the KZM is further configured to assign a key zone in the second plurality of key zones to a panel of the plurality of panels, and
wherein the event handler is further configured to display the panel in response to a selection of the key zone in the second plurality of key zones.

18. The system of claim 16, further comprising:
a filter module configured to extract a subset of a plurality of search results from a web page of the web site by applying a filter criterion of a plurality of filter criteria to the plurality of search results,
wherein the KZM is further configured to assign a key zone in the second plurality of key zones to the filter criterion, and
wherein the filter criterion is applied to the plurality of search results in response to a selection of the key zone in the second plurality of key zones, and
wherein the plurality of filter criteria corresponds to a plurality of search engines.

19. The system of claim 16, further comprising:
an advertisement engine configured to select an advertisement to populate a key zone of at least one selected from a group consisting of the first grid and the second grid,
wherein the advertisement is launched in response to a selection of the key zone.

20. The system of claim 16, further comprising:
a distribution module configured to share the first grid with a plurality of users using at least one selected from a group consisting of a social networking site, a 2D code, and a short message service (SMS).
